(19) United States
(12) Patent Application Publication
(10) Pub. No.: US 2011/0013933 A1
(43) Pub. Date: Jan. 20, 2011

(54) PROCESS CARTRIDGE AND IMAGE FORMING APPARATUS

(75) Inventor: Kensuke Sato, Ushiku-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/813,061

(22) Filed: Jun. 10, 2010

(30) Foreign Application Priority Data
Jul. 15, 2009 (JP) 2009-167069
Apr. 20, 2010 (JP) 2010-096876

(51) Int. Cl. G03G 21/16; G03G 15/09

(52) U.S. Cl. 399/111; 399/277

(57) ABSTRACT

A process cartridge that is provided with an image bearing member and a development device and is detachably attached to an apparatus body includes a developer carrying member that carries a developer, a magnetic member housed inside, an interval defining member that defines an interval between the surface of the developer carrying member and the surface of the image bearing member, and a support member that can support the magnetic member at a first position, at which a developing operation is performed, and a second position, at which a nearest distance between the surface of the developer carrying member and the surface of the magnetic member is greater than that at the first position.

### BACKGROUND OF THE INVENTION

1. Field of the Invention

The present invention relates to an image forming apparatus and a process cartridge that can be attached to or detached from an apparatus body of the image forming apparatus.

2. Description of the Related Art

An image forming apparatus. adopting an electrophotographic system includes a process cartridge integrally including a photosensitive member, on which an electrostatic latent image is formed, a charging roller for electrically charging the surface of the photosensitive member, and a developing device for supplying a developer to the electrostatic latent image so as to develop the image into a developer image. The process cartridge is detachably attached to an apparatus body of the image forming apparatus.

Furthermore, the developing device includes a hollow cylindrical developer carrying member for supplying the developer onto the photosensitive member, and further, has a magnetic member in the developer carrying member. With the magnetic member, the developer can be stably supplied onto the developer carrying member by the function of the magnetic member inside of the developing device.

The developer carrying member and the photosensitive member are configured such that their surfaces are separated from each other with a predetermined distance kept therebetween. A development bias is applied to the developer carrying member, and thus, a developing operation is performed. FIG. 20 is a cross-sectional view schematically showing a conventional process cartridge 1000. In FIG. 20, reference numeral 2070 denotes a photosensitive member; 2100d, a hollow cylindrical developer carrying member; and 2100c, a magnetic member housed inside of the developer carrying member.

In the above-described configuration, the developer carrying member 2100d is flexed due to an impact (e.g., a drop) during transportation of the process cartridge, and therefore, is brought into contact with the photosensitive member 2070, thereby possibly scarring the surface of the photosensitive member 2070. The scar on the surface of the photosensitive member 2070 induces image deficiency of a streak on an image formed on a sheet material. In view of this, Japanese Patent Applications Laid-open No. 2000-019800 and No. 2007-025127 disclose providing a protective sheet or a shock absorber between the photosensitive member and the developer carrying member as countermeasures against the problem.

However, the above -described configuration can prevent the contact per se between the developer carrying member and the photosensitive member, with another attendant drawback. The drawback is a damage or deformation of the developer carrying member or the magnetic member accompanied with elastic flexure of the magnetic member during the impact. The inventors earnestly studied and found that the drawback (i.e., a problem to be solved) occurred due to the following phenomenon.

Specifically, when the magnetic member is flexed due to the impact, the developer carrying member is flexed in such a manner that its inner circumference is pressed by the flexure. This induces a contact between the developer carrying member and the photosensitive member, thereby scarring the surface of the photosensitive member. Moreover, the flexed developer carrying member in contact with the photosensitive member cannot be released anymore, and therefore, the developer carrying member is further pressed by the flexed magnetic member, and consequently, a react ion force is generated between the developer carrying member and the magnetic member, thereby possibly inducing a damage or deformation on the developer carrying member or the magnetic member. Such a problem to be solved could not be solved by the conventional configurations.

### SUMMARY OF THE INVENTION

Therefore, an object of the present invention is to provide a process cartridge capable of preventing the surface of an image bearing member from being scarred without any damage or deformation on a developer carrying member or a magnetic member, or an image forming apparatus.

In order to achieve the above-described object, a process cartridge detachably attached to an apparatus body of an image forming apparatus includes an image bearing member, on which an electrostatic image is formed, a developer carrying member that carries and conveys a developer for developing the electrostatic image, a magnetic member that is housed inside of the developer carrying member, an interval defining member that defines an interval between the surface of the developer carrying member and the surface of the image bearing member, and a support member that supports the magnetic member in such a manner as to be movable inside of the developer carrying member between a first position, at which a developing operation is performed, and a second position, at which a nearest distance between the surface of the image bearing member and the surface of the magnetic member is greater than that at the first position.

In order to achieve the above-described object, an image forming apparatus includes an apparatus body, an image bearing member, on which an electrostatic image is formed, a developer carrying member that carries and conveys a developer for developing the electrostatic image, a magnetic member that is housed inside of the developer carrying member, an interval defining member that defines an interval between the surface of the developer carrying member and the surface of the image bearing member, and a support member that supports the magnetic member in such a manner as to be movable inside of the developer carrying member between a first position, at which a developing operation is performed, and a second position, at which a nearest distance between the surface of the image bearing member and the surface of the magnetic member is greater than that at the first position, wherein the image bearing member, the developer carrying member, the magnetic member, the interval defining member, and the support member are provided in a process cartridge that is detachably attached to the apparatus body, and an installation portion that is provided in the apparatus body and mounts the process cartridge thereon.

### BRIEF DESCRIPTION OF THE DRAWINGS

FIGS. 1A and 1B are cross-sectional views schematically showing an image forming apparatus in a first embodiment;

FIGS. 2A to 2C are views illustrating a method for attaching a process cartridge in the first embodiment;

FIGS. 3A to 3C are views illustrating installation of the process cartridge on a drive side in the first embodiment;

FIGS. 4A to 4C are views illustrating installation of the process cartridge on a non-drive side in the first embodiment;

FIGS. 5A to 5C are views schematically showing the configuration of the process cartridge on the drive side in the first embodiment;

FIGS. 6A and 6B are views schematically showing the configuration of the process cartridge on the non-drive side in the first embodiment;

FIGS. 7A and 7B are views schematically showing the configuration of the process cartridge in the first embodiment;

FIGS. 8A and 8B are views schematically showing the configuration of the process cartridge on the drive side in the first embodiment;

FIGS. 9A and 9B are views schematically showing the configuration of the process cartridge on the drive side in the first embodiment;

FIGS. 10A and 10B are views schematically showing the configuration of the process cartridge in a second embodiment;

FIGS. 11A and 11B are views schematically showing the configuration of the process cartridge on the drive side in the second embodiment;

FIGS. 12A and 12B are views schematically showing the configuration of the process cartridge on the drive side in the second embodiment;

FIGS. 13A and 13B are views schematically showing the configuration of the process cartridge in the second embodiment;

FIGS. 14A and 14B are views schematically showing the configuration of the process cartridge in the second embodiment;

FIGS. 15A and 15B are views schematically showing the configuration of the process cartridge in a third embodiment;

FIGS. 16A to 16C are views schematically showing the configuration of the process cartridge on the drive side in the third embodiment;

FIGS. 17A and 17B are views schematically showing the configuration of the process cartridge on a non-drive side in the third embodiment;

FIGS. 18A and 18B are longitudinally cross-sectional views schematically showing the process cartridge in the third embodiment;

FIGS. 19A and 19B are views schematically showing the configuration of the process cartridge in the third embodiment; and

FIG. 20 is a view schematically showing the configuration of a process cartridge in the prior art.

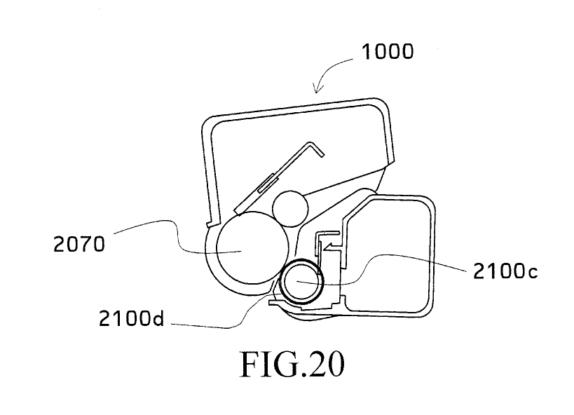

### DETAILED DESCRIPTION OF THE EMBODIMENTS

### First Embodiment

### (Schematic Configuration of Image Forming Apparatus)

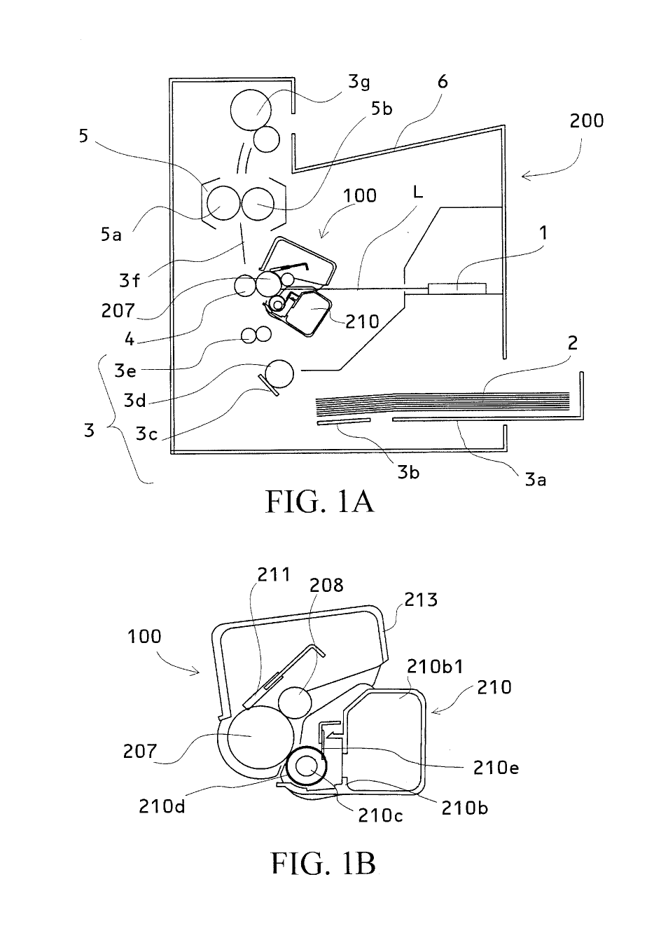

A description will be given below of the schematic configuration of an image forming apparatus provided with a process cartridge 100 in the present embodiment with reference to FIGS. 1A and 1B. FIG. 1A is a cross-sectional view schematically showing an image forming apparatus in the present embodiment, that is, shows the schematic configuration of a laser beam printer 200 that forms an image on a sheet material by an electrophotographic system.

The laser beam printer 200 includes the process cartridge 100 for forming a toner image (i.e., a developer image) on a sheet material. The process cartridge 100 is detachably attached to an apparatus body of the laser beam printer 200. Although only one process cartridge 100 is shown in FIGS. 1A and 1B, the number of process cartridges 100 is not limited to one. Specifically, process cartridges maybe disposed according to the kinds of toners (i.e., developer s) (Y: yellow; M: magenta; C: cyan; and B: black). Next, the configuration of the process cartridge 100 will be described below.

In forming an image, first, a photosensitive member 207 (i.e., an image bearing member) housed inside of the process cartridge 100 is irradiated with a laser beam L by an optical device 1 based on image information, and then, an electrostatic latent image (i.e., an electrostatic image) is formed on the photosensitive member 207. Thereafter, a toner is supplied to the electrostatic latent image formed on the photosensitive member 207 from a developing device 210 housed inside of the process cartridge 100, and thus, a toner image (i.e., a developer image) is formed on the photosensitive member 207.

On the other hand, sheet materials are sequentially fed from a feed tray 3a, on which the sheet materials are stacked, in synchronism with a timing at which the toner image is formed on the photosensitive member 207. Here, a lift-up plate 3b disposed at the tip of the feed tray 3a is lifted up, so that an uppermost sheet material 2 is conveyed to a transfer position, at which the toner image is transferred by a conveyance unit 3 including a conveyance roller 3d, a separation pad 3c, and registration rollers 3e.

Then, a voltage applying unit, not shown, applies a voltage having a polarity reverse to that of the toner image to a transfer roller 4, so that the toner image formed on the photosensitive member 207 is transferred onto the sheet material at the transfer position. Thereafter, the sheet material having the toner image transferred thereon is conveyed to a fixing device 5 by a conveyance guide 3f, and then, the toner image is thermally fixed onto the sheet material in the fixing device 5. The fixing device 5 includes a drive roller 5a and a fixing roller 5b incorporating a heater therein. The toner image on the sheet material is heated and pressurized at a fixing nip portion defined between the drive roller 5a and the fixing roller 5b. The sheet material having the toner image fixed thereto in the fixing device 5 is then discharged to a discharge unit 6 through discharge rollers 3g. Here, “the apparatus body” in the present embodiment indicates the laser beam printer 200 except the process cartridge 100.

### (Configuration of Process Cartridge)

Referring to FIG. 1B, description will be made on the configuration of the process cartridge 100 in the present embodiment. FIG. 1B is a schematically cross-sectional view showing the process cartridge 100, as viewed in a direction of a rotary shaft of a rotatable developing sleeve 210d disposed in the developing device 210 inside of the process cartridge 100. Hereinafter, the description will be made while the direction of the rotary shaft of the developing sleeve 210d is referred to as the longitudinal direction of the process cartridge 100.

As shown in FIG. 1B, the process cartridge 100 includes the drum-like rotatable photosensitive member 207, around which a plurality of members are provided for forming the toner image on the photosensitive member 207. Here, the members that are provided around the photosensitive member 207 and are adapted to form the toner image on the photosensitive member 207 are integrally referred to as “process means.”

The process means includes a charging member 208 for electrically charging the surface of the photosensitive member 207, the developing device 210 for developing the electrostatic latent image formed on the photosensitive member 207 as a toner image, and a cleaning member 211 for removing the toner remaining on the surface of the photosensitive member 207. Moreover, the developing device 210 includes a development frame 210b; in contrast, the cleaning member 211 includes a cleaner frame 213. These frames define a housing for the entire process cartridge 100, and therefore, the photosensitive member 207 and the process means can be detachably attached to the apparatus body in an integral manner. Here, the photosensitive member 207 is configured in such a manner as to receive a drive force on one side (i.e., a drive side) in the longitudinal direction.

A detailed description will be further given of the configuration of the developing device 210. Inside of the above-described development frame 210b is rotatably disposed the developing sleeve 210d (i.e., a hollow cylindrical developer carrying member) for carrying the toner contained in a development container 210b1 thereon so as to supply the toner onto the surface of the photosensitive member 207. The developing sleeve 210d incorporates therein a rod-like magnetic member 210c having substantially the same longitudinal dimension as that of the developing sleeve 210d. The developing sleeve 210d is rotatably supported by the development container 210b1. As a consequence, the toner supplied from the development container 210b1 adheres onto the developing sleeve 210d by the magnetic force of the magnetic member 210c, and then, is restricted to a constant thickness by a development blade 210e. Thereafter, the toner is supplied to the electrostatic latent image formed on the photosensitive member 207 from the developing sleeve 210d at a position at which the developing sleeve 210d and the photosensitive member 207 face each other, so that the electrostatic latent image is developed as the toner image.

### (Installation of Process Cartridge on Drive and Non-Drive Sides)

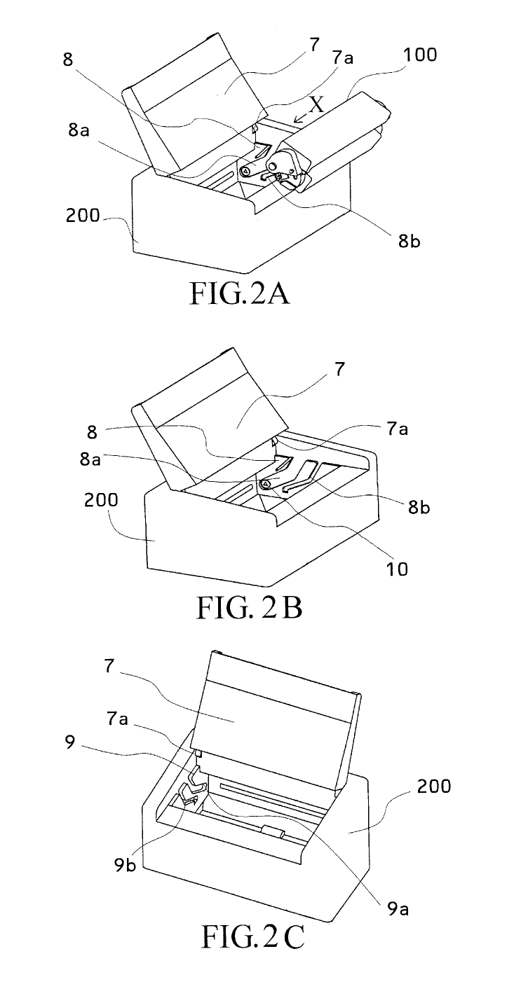

Next, description will be made on a process when the process cartridge 100 is installed in the apparatus body of the laser beam printer 200. FIG. 2A shows the state in which the process cartridge 100 is installed in the laser beam printer 200 in the present embodiment. When the process cartridge 100 is insertingly disposed in the laser beam printer 200, first, an opening/closing member 7 is opened upward on a hinge 7a, and then, the process cartridge 100 is inserted in a direction indicated by an arrow X in FIG. 2A. Consequently, the process cartridge 100 is guided in the insertion direction by an installing mechanism such as a guide groove formed in the laser beam printer 200, so that the process cartridge 100 is located on its drive and non-drive sides at a predetermined position in the apparatus body.

“The drive side” of the process cartridge 100 herein indicates a side, on which a drive force (i.e., a drive force for driving the photosensitive member 207) is input from a driving unit disposed in the laser beam printer 200, in the longitudinal direction of the process cartridge 100. In contrast, “the non-drive side” indicates a reverse side. As for the apparatus body of the laser beam printer 200, a side facing “the drive side” of the process cartridge is referred to as “a drive side (of the laser beam printer)” whereas a reverse side is referred to as “a non-drive side (of the laser beam printer). ” In FIGS. 2A and 2B, the back side is “the drive side” whereas the front side is “the non-drive side.”

As shown in FIG. 2B, on the drive side of the laser beam printer 200, there is provided a main body guide member 8 on the drive side, for guiding the process cartridge 100 on the drive side. The main body guide member 8 on the drive side includes an upper guide groove 8a and a lower guide groove 8b. As shown in FIG. 2C, on the non-drive side of the laser beam printer 200, there is provided a main body guide member 9 on the non-drive side, for guiding the process cartridge 100 on the non-drive side. The main body guide member 9 on the non-drive side includes an upper guide groove 9a and a lower guide groove 9b. The main body guide member 8 on the drive side and the main body guide member 9 on the non-drive side constitute an installation portion, to which the process cartridge 100 is installed.

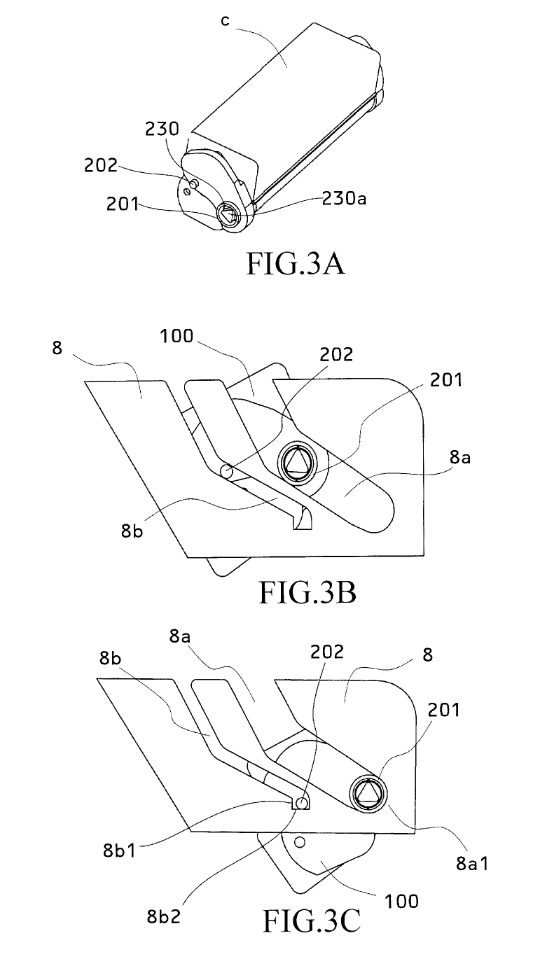

Referring to FIGS. 3A to 3C, description will be made on the installation process (the installing operation) of the process cartridge 100 on the drive side. FIGS. 3A to 3C show the configuration of the process cartridge 100 on the drive side, being explanatory of the installation process on the drive side. A positioning boss 201 on the drive side, disposed on the drive side in a photosensitive unit c of the process cartridge 100 is inserted into the upper guide groove 8a of the main body guide member 8 on the drive side whereas a stopper boss 202 engages with the lower guide groove 8b, thereby achieving the installation on the drive side. When the process cartridge 100 is further pushed, the positioning boss 201 on the drive side, of the process cartridge 100 drops in a main body positioning portion 8a1 formed at the distal end of the upper guide groove 8a, as shown in FIG. 3C. In the same manner, the stopper boss 202 drops in a rotational position restriction portion 8b1 formed at the distal end of the lower guide groove 8b, and then, abuts against a rotational position restriction surface 8b2. In this manner, the process cartridge 100 is positioned on the drive side.

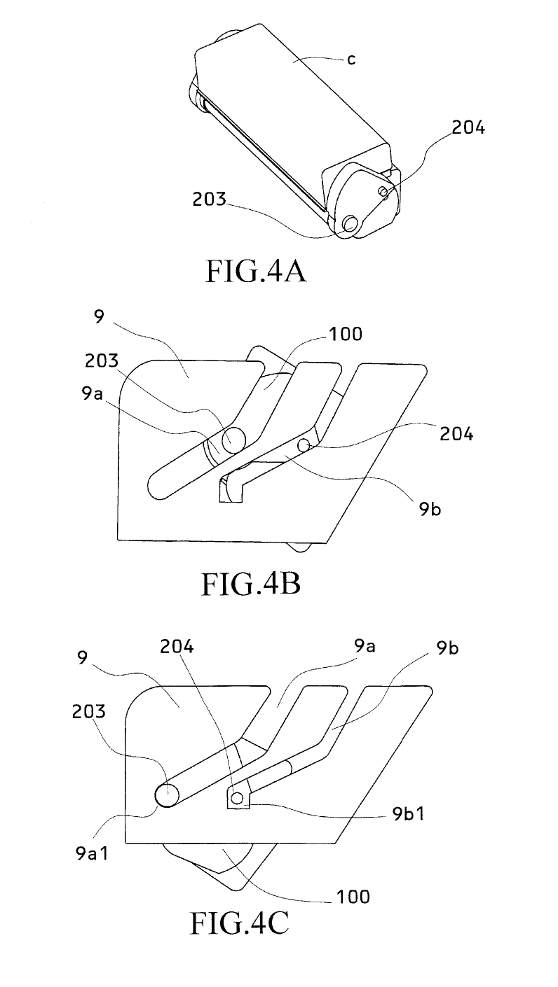

Referring to FIGS. 4A to 4C, description will be made on the installation process (the installing operation) of the process cartridge 100 on the non-drive side. FIGS. 4A to 4C show the configuration of the process cartridge 100 on the non-drive side, being explanatory of the installation process on the non-drive side. A positioning boss 203 on the non-drive side, disposed on the non-drive side in the photosensitive unit c of the process cartridge 100 is inserted into the upper guide groove 9a of the main body guide member 9 on the non-drive side whereas a unit guide boss 204 insertingly engages with the lower guide groove 9b, thereby achieving the installation on the non-drive side. When the process cartridge 100 is further pushed, the positioning boss 203 on the non-drive side drops in a rotational position restriction portion 9a1 formed at the distal end of the upper guide groove 9a, as shown in FIG. 4C. In the same manner, the unit guide boss 204 drops in a receiving recess 9b1 formed at the distal end of the lower guide groove 9b. In this manner, the process cartridge 100 is positioned on the non-drive side.

With the above-described installation process, the process cartridge 100 is restrictedly inserted by the pair of upper guide groove 8a and lower guide groove 8b on the drive side whereas it is inserted and restricted by the upper guide groove 9a and the lower guide groove 9b on the non-drive side, so that the process cartridge 100 is located at the predetermined position. When the process cartridge 100 is installed, the drive force can be input into the photosensitive member 207 from the laser beam. printer 200 in association with the installing operation. Here, when the cover member 7 is closed, the laser beam printer 200 is configured such that a coupling recess 10 (FIG. 2B) in the laser beam printer 200 intrudes inward to be then fitted to a coupling projection 230a (FIG. 3A) formed integrally with a drum flange 230 at a side end of the photosensitive member 207. When the coupling projection 230a engages with the coupling recess 10, the drive force can be transmitted from a drive source on the side of the laser beam printer 200 to the photosensitive member 207 through the coupling recess 10.

(Configuration for Moving Magnetic member)

In the process cartridge 100 in the present embodiment, the magnetic member 210c housed inside of the developing sleeve 210d is configured in such a manner as to be movable, thereby preventing the developing sleeve 210d from being flexed due to the impact or vibrations imparted on the process cartridge. Specifically, the magnetic member 210c is moved to a second position at which a nearest distance between the surface of the magnetic member 210c and the surface of the photosensitive member 207 can be kept large during the transportation whereas it is moved to a first position at which the nearest distance can be narrowed during the use of the image forming apparatus (i.e. , during the developing operation). Hereinafter, description will be made on the configuration in which the magnetic member 210c can be moved inside of the developing sleeve 210d (i.e., the developer carrying member) while keeping the axes of the magnetic member 210c and the developing sleeve 210d in parallel to each other.

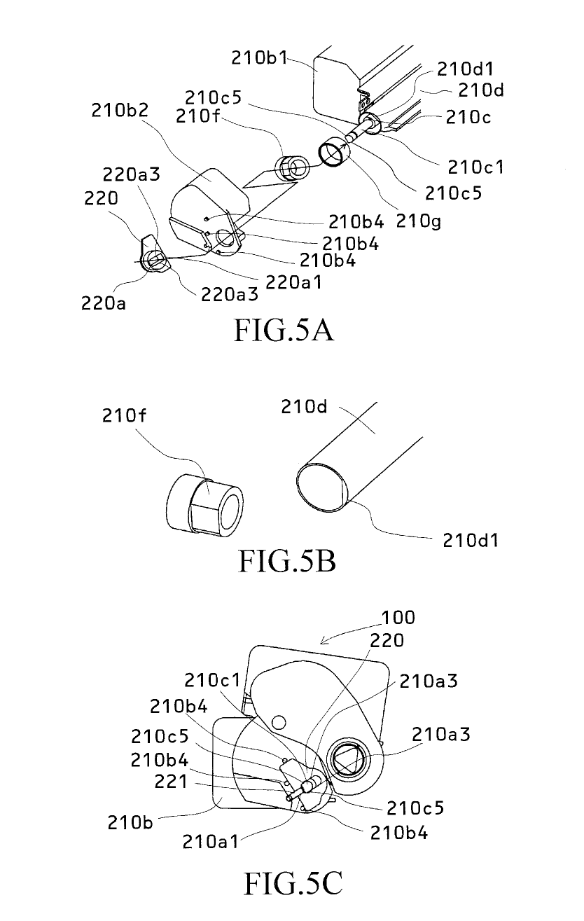

First, referring to FIGS. 5A to 5C, a description will be given of the configuration in which the magnetic member 210c can be moved on the drive side of the process cartridge 100. FIG. 5A is a partly perspective view showing the process cartridge 100 on the drive side in the present embodiment. A projection 210c1 on the drive side is attached to an end of the magnetic member 210c on the drive side. The magnetic member 210c is supported on the drive side thereof by a bearing 220 (i.e., a support member) on the drive side, and further, the bearing 220 on the drive side is positioned by bearing positioning ribs 210b4 on the drive side to be supported by a holder 210b2 on the drive side. Moreover, the holder 210b2 on the drive side is supported by the development container 210b1. In other words, all of the members shown in FIGS. 5A to 5C are disposed on the side of the process cartridge 100.

An end of the developing sleeve 210d on the drive side (i.e., a sleeve end 210d1 on the drive side) has a D-cut shape (FIG. 5B). A sleeve gear 210f is engageably fixed to the sleeve end 210d1 on the drive side via a spacer roll 210g. The spacer roll 210g is an interval defining member which defines a predetermined interval between the surface of the sleeve and the surface of the photosensitive member in abutment against the photosensitive member. The inner circumference of the sleeve gear 210f is configured to slide on the bearing 220 on the drive side, thereby allowing the developing sleeve 210d to be rotated via the sleeve gear 210f by a driving unit, not shown.

The bearing 220 on the drive side has an elongated circular hole (i.e., a slot) formed substantially in parallel to a virtual line connecting the rotational center of the photosensitive member 207 and the rotational center of the developing sleeve 210d while being supported by the holder 210b2 on the drive side, that is, a magnetic member movement restriction hole 220a on the drive side. The projection 210c1 of the magnetic member 210c on the drive side is fitted to the magnetic member movement restriction hole 220a on the drive side. As a consequence, the phase of a D-cut slide portion 210c5 on the drive side is fixed by the engagement of the D-cut slide portion 210c5 with a slide surface 220a3 of the magnetic member movement restriction hole 220a on the drive side, so that the magnetic member 210c can be movably supported by the bearing 220 on the drive side.

FIG. 5C is a side view showing the process cartridge 100 on the drive side. The magnetic member 210c is urged oppositely to the photosensitive member 207 by a tension spring 221 (i.e., an urging member) on the drive side, to be pressed against a first abutment surface 220a1 of the magnetic member movement restriction hole 220a on the drive side, and thus, is positioned at the second position (FIG. 5C). The tension spring 221 on the drive side is fixed to the holder 210b2 on the drive side.

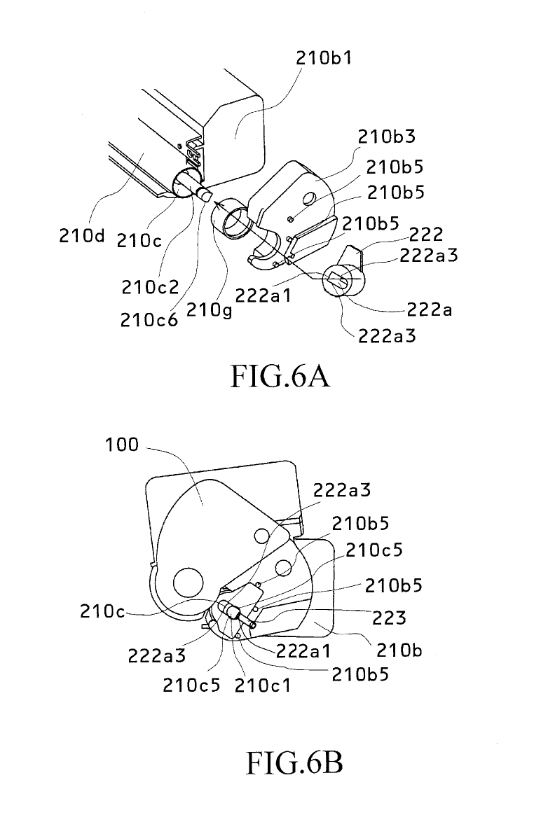

Next, referring to FIGS. 6A and 6B, description will be made on the configuration for enabling the magnetic member 210c to be moved on the non-drive side of the process cartridge 100. FIG. 6A is a partly perspective view showing the process cartridge 100 on the non-drive side in the present embodiment. The configuration on the non-drive side is substantially identical to that on the drive side. A projection 210c2 on the non-drive side having the same shape as that of the projection on the drive side is formed on the non-drive side of the magnetic member 210c. The developing sleeve 210d is supported on the non-drive side thereof by a bearing 222 on the non-drive side while holding the spacer roll 210g therebetween. The bearing 222 on the non-drive side is supported by bearing positioning ribs 210b5 on the non-drive side and a holder 210b3 on the non-drive side. The holder 210b3 on the non-drive side is supported by the development container 210b1.

The bearing 222 on the non-drive side has an elongated circular hole formed substantially in parallel to a line connecting the rotational center of the photosensitive member 207 and the rotational center of the developing sleeve 210d while being supported by the holder 210b3 on the non-drive side, that is, a hole 222a for restricting the movement of the magnetic member on the non-drive side. The phase of a D-cut slide portion 210c6 on the non-drive side is fixed by the engagement of the D-cut slide portion 210c6 with a slide surface 222a3 of the magnetic member movement restricting hole 222a, so that the magnetic member 210c can be movably supported by the bearing 222 on the drive side.

FIG. 6B is a side view showing the process cartridge 100 on the non-drive side. The magnetic member 210c is urged oppositely to the photosensitive member 207 by a tension spring 223 on the non-drive side, to be pressed against a first abutment surface 222a1 of the magnetic member movement restricting hole 222a on the non-drive side, and thus, is positioned at the second position (FIG. 6B).

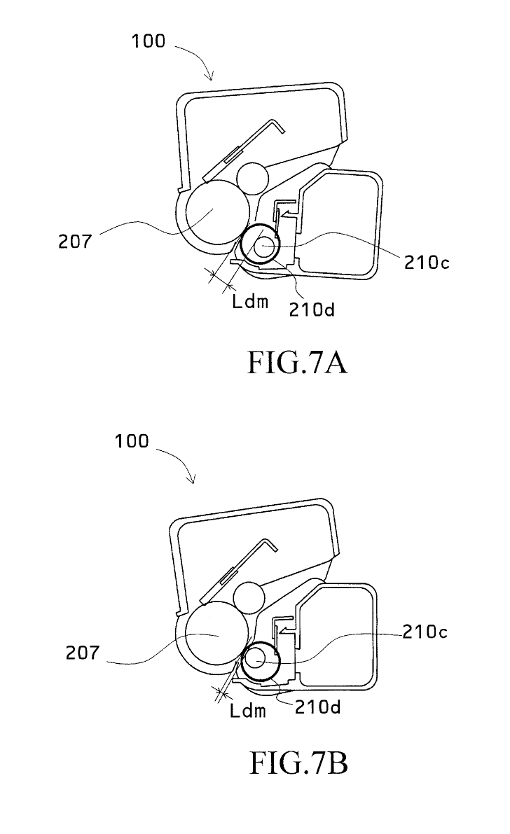

As described above, the magnetic member 210c can be moved oppositely to the photosensitive member 207 to be positioned thereat by the effect of the tension spring 221 on the drive side and the tension spring 223 on the non-drive side in the state in which the process cartridge 100 is not disposed in the laser beam printer 200. This position is referred to as a second position. As shown in FIG. 7A, when the magnetic member 210c is located at the second position, the nearest distance (Ldm) between the surface of the photosensitive member 207 and the surface of the magnetic member 210c can be kept large. More specifically, the magnetic member 210c can be positioned at a position opposite to the photosensitive member 207 with respect to the rotational center of the developing sleeve 210d.

Subsequently, a description will be given of a configuration for moving the magnetic member 210c toward the photosensitive member 207 when the process cartridge 100 is disposed in the laser beam printer 200 so as to position it at the first position at which the developing operation is performed.

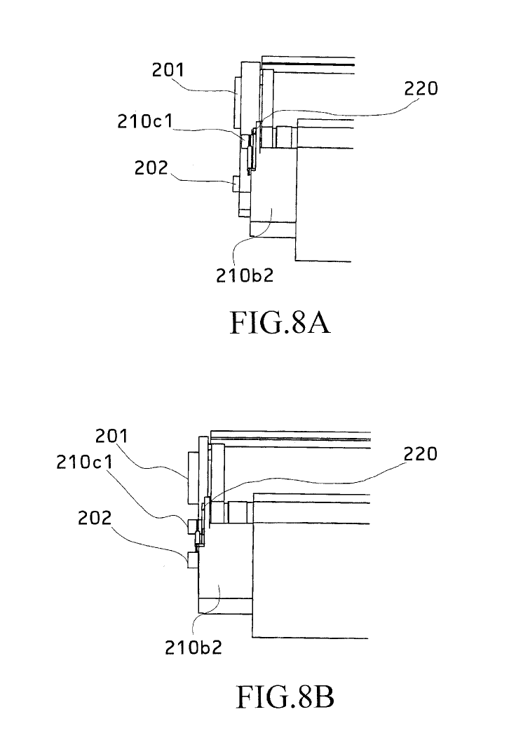

FIG. 8A is a view showing the schematic configuration of the process cartridge 100 on the drive side, as viewed in the direction perpendicular to the longitudinal direction. As shown in FIG. 8A, the projection 210c1 on the drive side of the magnetic member 210c projects longitudinally outward of the holder 210b2 on the drive side (the projection 210c2 on the non-drive side also has the same configuration). The positioning boss 201 on the drive side and the stopper boss 202 are arranged outward of the projection 210c1 on the drive side in the longitudinal direction (the same configuration is provided on the non-drive side). As a consequence, when the process cartridge 100 is disposed in the laser beam printer 200, the projections formed at both ends of the magnetic member 210c in the longitudinal direction cannot be brought into contact with the main body guide member 8 on the drive side and the main body guide member 9 on the non-drive side.

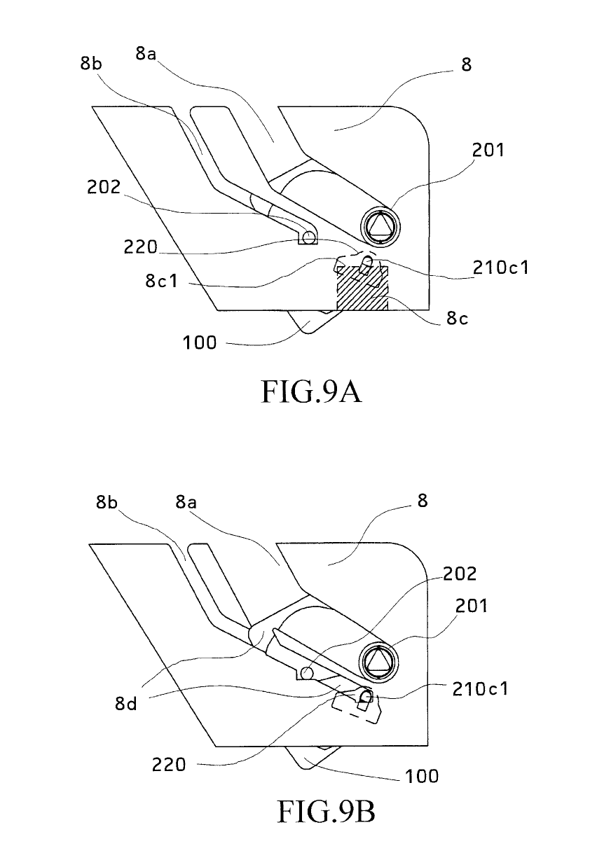

FIGS. 9A and 9B are side views showing the process cartridge 100 on the drive side when the process cartridge 100 is installed in the laser beam printer 200. As shown in FIG. 9A, the main body guide member 8 on the drive side has a magnetic member pushing rib 8c on the drive side (i.e., a force applying portion) indicated by a slash. The force applying portion constitutes a part of the apparatus body. When the process cartridge 100 is installed in the laser beam printer 200, the projection 210c1 on the drive side (i.e., a force receiving portion) abuts against a pushing rib abutment surface 8c1 of the magnetic member pushing rib 8c on the drive side. Then, as the process cartridge 100 is inserted, the projection 210c1 on the drive side is moved toward the photosensitive member 207 inside of the magnetic member movement restriction hole 220a on the drive side against the urging force of the tension spring 221 on the drive side by the force received from the pushing rib abutment surface 8c1 , to be then positioned at the first position. Furthermore, this movement enables the developing sleeve 210d to be pushed toward the photosensitive member 207.

The same configuration as that on the drive side described above is provided on the non-drive side of the process cartridge 100. Specifically, the projection 210c2 (i.e., a force receiving portion) on the non-drive side is moved by a magnetic member pushing rib (i.e., a force applying portion) , not shown, formed on the main body guide member 9 on the non-drive side. As a consequence, when the process cartridge 100 is disposed in the laser beam printer 200, the magnetic member 210c is moved toward the photosensitive member by the effects of the main body guide member 8 on the drive side and the main body guide member 9 on the non-drive side. Consequently, the magnetic member 210c is positioned at the first position shown in FIG. 7B.

Although the above description has been given of the case where the positioning boss 201 on the drive side and the stopper boss 202 are arranged outward of the projection 210c1 on the drive side of the magnetic member 210c in the longitudinal direction, as shown in FIG. 8A, the configuration in the present embodiment is not limited to this. In other words, as shown in FIG. 8B, the positioning boss 201 on the drive side and the stopper boss 202 may be substantially flush with the projection 210c1 on the drive side of the magnetic member 210c (the same goes for the non-drive side). In this case, as shown in FIG. 9B, the above-described magnetic member pushing rib 8c on the drive side may not be provided, but a groove 8d may be formed on the main body guide member 8 on the drive side so as to allow the projection 210c1 on the drive side to pass therethrough such that the projection 210c1 on the drive side is pushed at the distal end of the groove 8d. With this configuration, the positioning boss 201 on the drive side and the stopper boss 202 can be substantially flush with the projection 210c1 on the drive side of the magnetic member 210c in the longitudinal direction, and therefore, the longitudinal dimension of the process cartridge 100 can be reduced.

As described above, in the present embodiment, before the process cartridge 100 is installed in the laser beam printer 200, the magnetic member 210c can be largely separated from the photosensitive member 207. As a consequence, even if the magnetic member 210c is flexed due to the impact or vibrations onto the process cartridge, the developing sleeve 210d pushed into the flexed magnetic member can reduce the possibility of the contact with the photosensitive member 207. Alternatively, even if the magnetic member is flexed to push the inner surface of the developing sleeve, no large reaction force is imparted on the magnetic member from the developing sleeve unless the developing sleeve pushes the photosensitive drum, thereby suppressing any damage or de formation of the magnetic member or the developing sleeve. In addition, when the process cartridge 100 is installed, the installing operation causes the magnetic member 210c to be moved toward the photosensitive member 207. Thus, the magnetic member can be moved by the simple configuration without requiring a user to do cumbersome work.

### Second Embodiment

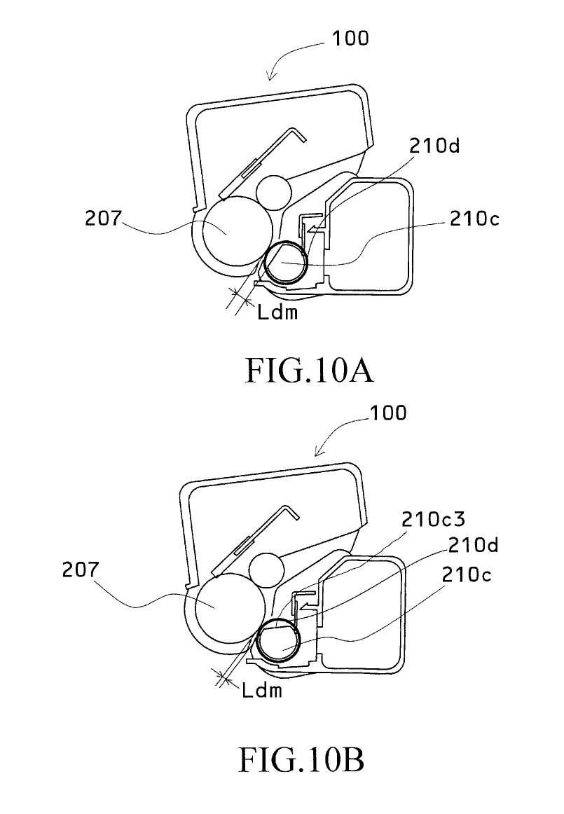

Referring to FIGS. 10 to 14, a description will be given of a process cartridge 100 in a second embodiment, to which the present invention is applicable. Here, the configuration of an image forming apparatus and the basic configuration of the process cartridge 100 are identical to those in the first embodiment, and therefore, their description will not be given below. The description will be given below of only matters different from those in the first embodiment.

FIGS. 10A and 10B are views schematically showing the configuration of the process cartridge in a longitudinal direction in the present embodiment. FIG. 10A shows a state before the process cartridge 100 is installed whereas FIG. 10B shows a state after the process cartridge 100 is installed.

As shown in FIGS. 10A and 10B, a magnetic member 210c is disposed coaxially with a developing sleeve 210d, and is formed into a D-cut shape (i.e., a non-circular shape) in a cross section perpendicular to the axial direction. Before the installation of the process cartridge 100, a straight portion of the D-cut shape faces a photosensitive member 207 . In other words, the phase of the magnetic member 210c is determined so as to make greatest a nearest distance between the surface of the photosensitive member 207 and the surface of the magnetic member 210c.

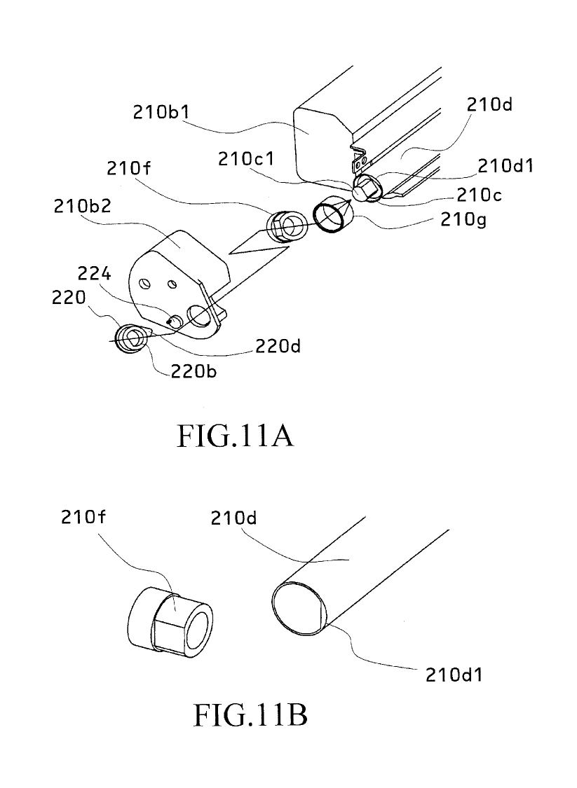

First, description will be made on the configuration of the process cartridge 100 on a drive side. FIG. 11A is a view showing the schematic configuration of the process cartridge on the drive side in the present embodiment. A projection 210c1 on the drive side is formed at a longitudinal end of the magnetic member 210c on the drive side. The projection 210c1 on the drive side is formed into a D-cut shape in a cross section. The projection 210c1 on the drive side is supported by a bearing 220 on the drive side (i.e., a support member) . The bearing 220 on the drive side is rotatably supported by a holder 210b2 on the drive side. In addition, the holder 210b2 on the drive side is supported by a development container 210b1.

As shown in FIG. 11B, the end of the developing sleeve 210d on the drive side has a sleeve end 210d1 on the drive side having a D-cut shape. A sleeve gear 210f is engageably fixed to the sleeve end 210d1 on the drive side via a spacer roll 210g. The inner circumference of the developing sleeve 210d is fitted around the sleeve gear 210f which can slide on the bearing 220 on the drive side. In other words, the developing sleeve 210d can be rotated via the sleeve gear 210f by a driving unit, not shown.

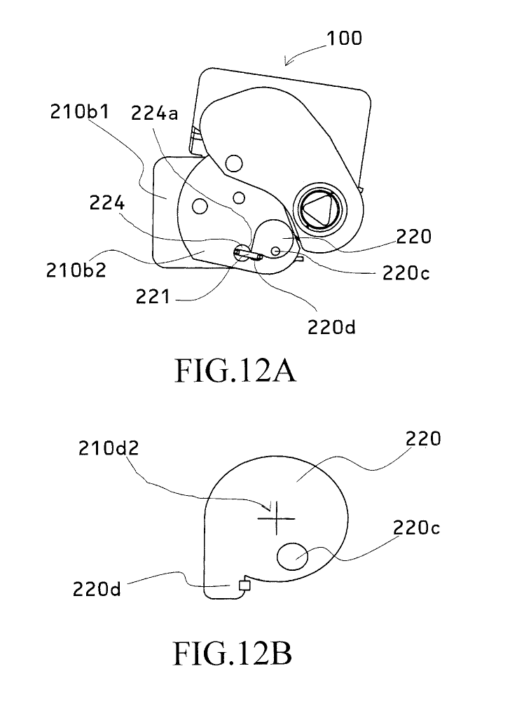

The bearing 220 on the drive side has a D-cut recess 220b fitted to the D-cut shaped portion of the projection 210c1 on the drive side. The magnetic member 210c is supported in engagement of the projection 210c1 on the drive side with the D-cut recess 220b. With this configuration, the bearing 220 on the drive side (i.e., the support member) supports the magnetic member in such a manner as to be rotated together with the magnetic member 210c. As shown in FIG. 12B, the bearing 220 on the drive side includes a rotation driving boss 220c and a rotation restricting abutment 220d.

FIG. 12A is a view showing the process cartridge 100 in the present embodiment, as viewed sideways on the drive side. A tension spring 221 on the drive side is locked to the rotation restricting abutment 220d (i.e., a locking portion) in the bearing 220 on the drive side. As a consequence, the bearing 220 on the drive side is rotated with the application of an urging force, and then, is pressed against an abutment surface 224a of a rotation restricting rib 224 disposed in the holder 210b2 on the drive side, to be thus positioned thereat. This position is referred to as a second phase (i.e., a second position). In this manner, the projection 210c1 on the drive side in the magnetic member 210c is urged, thereby enabling the magnetic member 210c to come to the state shown in FIG. 10A. In this state, the nearest distance between the surface of the magnetic member 210c and the surface of the photosensitive member 207 is greatest.

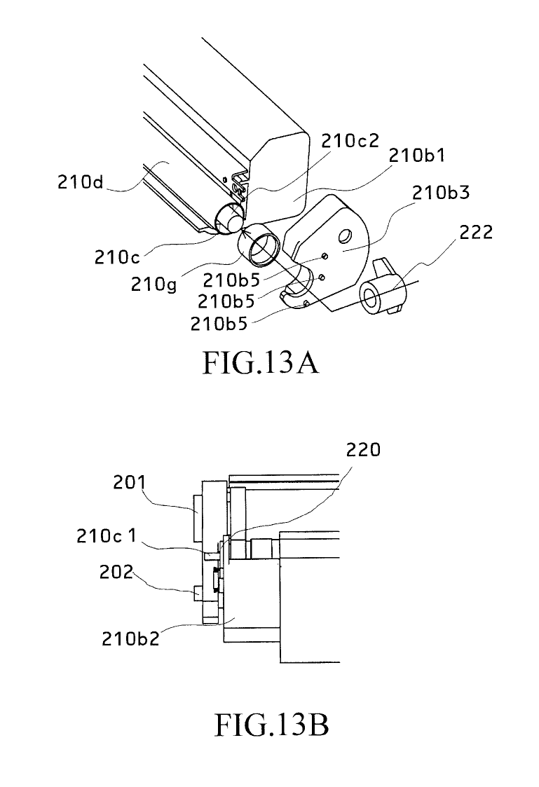

Next, a description will be given of the configuration of the process cartridge 100 on a non-drive side. FIG. 13A is a partly perspective view showing the process cartridge 100 on the non-drive side. A projection 210c2 on the non-drive side is formed at an end of the magnetic member 210c on the non-drive side, is formed into a circular shape in a cross section on a rotational center of the developing sleeve 210d. The developing sleeve 210d and the magnetic member 210c are slidably supported on the non-drive side by a bearing 222 on the non-drive side while holding the spacer roll 210g therebetween. The bearing 222 on the non-drive side is fixingly positioned at a holder 210b3 on the non-drive side via bearing positioning ribs 210b5 on the non-drive side. With this configuration, the magnetic member 210c is urged on the drive side of the process cartridge 100 in the above-described process, and is rotated to be positioned, so that the projection 210c2 on the non-drive side is rotated accordingly.

FIG. 13B is a view showing the process cartridge 100 on the drive side, as viewed in a direction perpendicular to the longitudinal direction. As shown in FIG. 13B, the projection 210c1 on the drive side in the magnetic member 210c is disposed longitudinally outward of the holder 210b2 on the drive side. Moreover, a positioning boss 201 and a stopper boss 202 on the drive side are arranged longitudinally outward of the projection 210c1 on the drive side. As a consequence, when the process cartridge 100 is installed in the laser beam printer 200, the process cartridge 100 can be inserted without bringing the bearing 220 on the drive side into contact with a main body guide member 8 on the drive side (the same configuration is provided on the non-drive side).

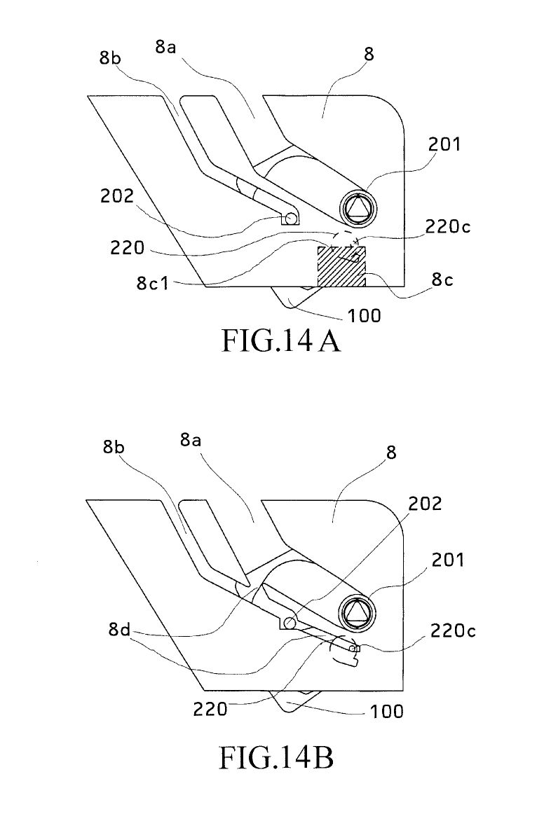

FIG. 14A is a side view showing the process cartridge 100 on the drive side when the process cartridge 100 is installed in the laser beam printer 200. During the installation of the process cartridge 100, the rotation driving boss 220c (i.e., a force receiving portion) in the bearing 220 on the drive side abuts against a pushing rib abutment surface 8c1 of a magnetic member pushing rib 8c (i.e., a force applying portion) disposed in the main body guide member 8 on the drive side, indicated by a slash. Here, the magnetic member pushing rib 8c (i.e., a force applying portion) on the drive side constitutes a part of an apparatus body. The rotation driving boss 220c is rotationally pushed against the urging force of the tension spring 221 on the drive side, and then, the magnetic member 210c is rotationally moved on the rotational center of the developing sleeve 210d, thereby varying the phase of the magnetic member 210c. As a consequence, the magnetic member 210c is positioned at the first phase (i.e., the first position) shown in FIG. 103. At the first position, a developing operation is performed based on the state of the first position. Here, the force generated when the magnetic member 210c is rotated in abutment of the rotation driving boss 220c against the pushing rib abutment surface 8c1 may be utilized as force for causing the developing sleeve 210d to approach the photosensitive member 207.

Although the above description has been given of the case where the positioning boss 201 on the drive side and the stopper boss 202 are arranged outward of the projection 210c1 on the drive side of the magnetic member 210c in the longitudinal direction, as shown in FIG. 13B, the configuration in the present embodiment is not limited to this. In other words, the positioning boss 201 on the drive side and the stopper boss 202 may be substantially flush with the projection 210c1 on the drive side of the magnetic member 210c. In this case, as shown in FIG. 14B, the above-described magnetic member pushing rib 8c on the drive side may not be provided, but a groove 8d may be formed on the main body guide member 8 on the drive side so as to allow the projection 210c1 on the drive side to pass therethrough such that the projection 210c1 on the drive side is pushed at a distal end of the groove 8d. With this configuration, the positioning boss 201 on the drive side and the stopper boss 202 can be substantially flush with the projection 210c1 on the drive side of the magnetic member 210c, and therefore, the longitudinal dimension of the process cartridge 100 can be reduced.

Moreover, although the magnetic member 210c is formed into the D-cut shape in a cross section perpendicular to the axial direction thereof in the present embodiment, the cross-sectional shape of the magnetic member 210c is not limited to this. Specifically, the magnetic member 210c may be formed such that the nearest distance between the surface of the magnetic member 210c and the surface of the photosensitive member 207 includes at least two kinds of distances (i.e., the magnetic member 210c may be formed into a non-circular shape). In addition, although the rotational force is applied to the magnetic member 210c only on the drive side of the process cartridge 100 in the present embodiment, the rotational force may be applied to the magnetic member 210c also on the non-drive side.

As described above, in the present embodiment, before the process cartridge 100 is installed in the laser beam printer 200, the magnetic member 210c having the D-cut cross section can be largely separated from the photosensitive member 207. As a consequence, even if the magnetic member 210c is flexed due to the impact or vibrations on the process cartridge, it is possible to reduce the possibility of the contact of the developing sleeve 210d pushed by the flexed magnetic member with the photosensitive member 207. Alternatively, even if the magnetic member is flexed to push the inner surface of the developing sleeve, no large reaction force is imparted on the magnetic member from the developing sleeve unless the developing sleeve pushes the photosensitive member, thereby suppressing any damage or deformation o f the magnetic member or the developing sleeve.

In addition, when the process cartridge 100 is installed, the installing operation causes the magnetic member 210c to be rotationally moved. Thus, the magnetic member can be moved by the simple configuration without requiring a user to do cumbersome work.

### Third Embodiment

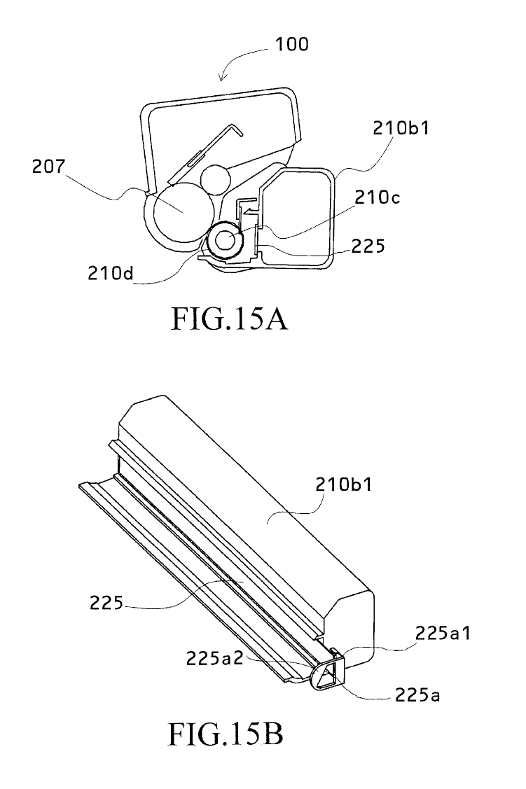

Referring to FIGS. 15 to 19, a description will be given of a process cartridge 100 in a third embodiment, to which the present invention is applicable. Here, the configuration of an image forming apparatus and the basic configuration of the process cartridge 100 are identical to those in the first and second embodiments, and therefore, their description will not be repeated below. The description will be given below of only matters different from those in the first and second embodiments.

FIGS. 15A and 15B are views schematically showing the configuration of the process cartridge 100 in the present embodiment, wherein FIG. 15A is a view schematically showing the configuration of the process cartridge 100, as viewed in a longitudinal direction, whereas FIG. 15B is a view schematically showing the configuration of a development container 210b1 housed inside of the process cartridge 100. According to the present embodiment, a developing sleeve 210d and a photosensitive member 207 cannot be brought into contact with each other even if an impact, a vibration, or the like occurs in a laser beam printer 200 in a state in which the process cartridge 100 is installed in the laser beam printer 200.

The process cartridge 100 includes a toner seal member 225 for sealing a toner contained inside of the development container 210b1 (FIG. 15A) . The toner seal member 225 is provided with a pull-tab 225a to be used as a grip in withdrawing, and further, a pull-tab root 225a1 can be bent (FIG. 15B) . When the process cartridge 100 is used, the toner seal member 225 is pulled out, and then, the development container 210b1 is released from being sealed. Here, the state before the toner seal member 225 is pulled out is defined as “a non-use state” of the process cartridge 100.

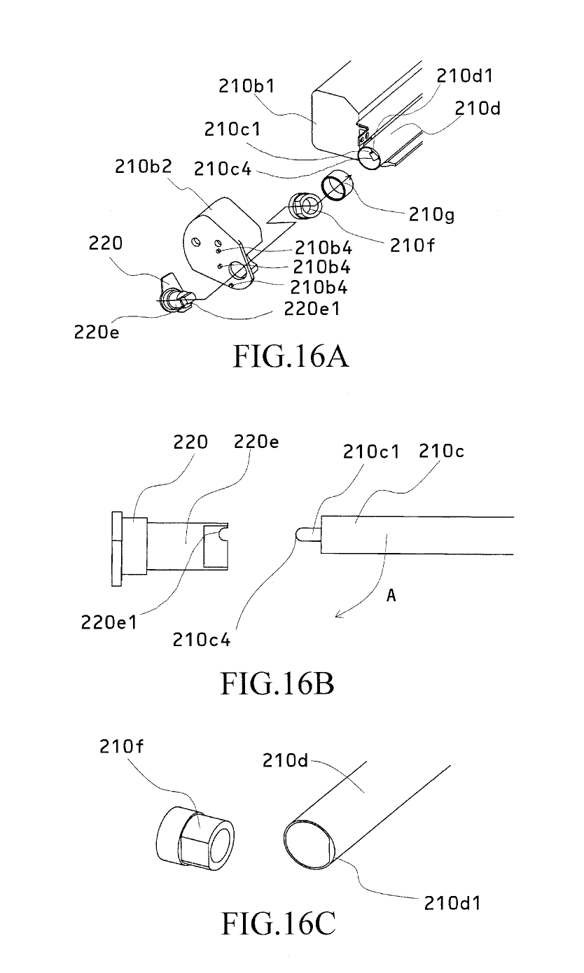

Next, a description will be given below of the configuration of the process cartridge 100 on a drive side. FIG. 16A is a view schematically showing the configuration of the process cartridge 100 on the drive side. A projection 210c1 on the drive side, having a rotation center 210c4 is formed at an end of a magnetic member 210c on the drive side. FIG. 16B is a view showing, in enlargement, the projection 210c1 on the drive side and a bearing 220 on the drive side, on which the projection 210c1 on the drive side is supported.

The magnetic member 210c is supported on the drive side thereof by the bearing 220 on the drive side, and further, the bearing 220 on the drive side is positioned by bearing positioning ribs 210b4 on the drive side to be supported by a holder 210b2 on the drive side. Moreover, the holder 210b2 on the drive side is supported by the development container 210b1. As shown in FIG. 16C, the end of the developing sleeve 210d on the drive side has a sleeve end 210d1 on the drive side, formed into a D-cut shape. A sleeve gear 210f is fixed in engagement therewith while holding a spacer roll 201g. In addition, the inner circumference of the sleeve gear 210f and the bearing 220 on the drive side can slide on each other. Consequently, a drive force is transmitted to the developing sleeve 210d via the sleeve gear 210f from a driving unit, not shown.

The bearing 220 on the drive side includes a bearing slide portion 220e on the drive side, in which a U-shaped groove 220e1 to be fitted around the rotational center 210c4 of the magnetic member 210c is formed (FIG. 16B) . The rotational center 210c4 is fitted into the U-shaped groove 220e1, so that the magnetic member 210c is supported on the drive side by the bearing 220 on the drive side in such a manner as to be rotatable on the rotational center 210c4 in a direction indicated by an arrow A.

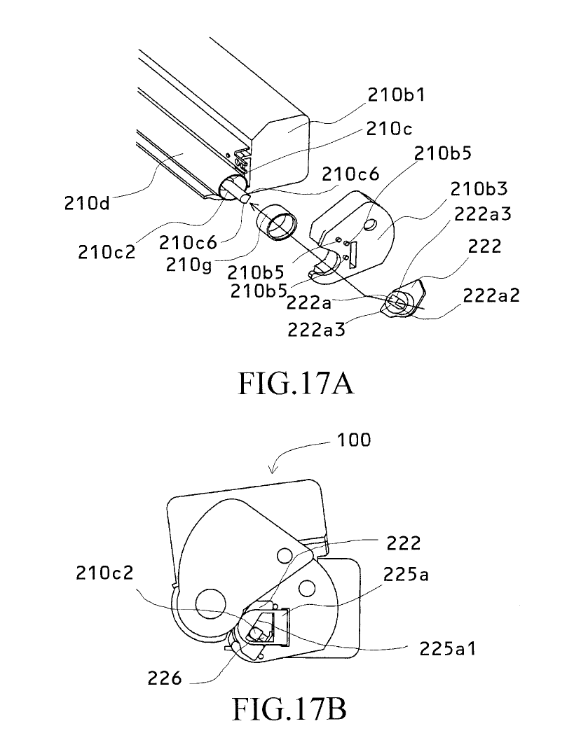

Next, a description will be given of the configuration of the process cartridge 100 on a non-drive side. FIG. 17A is a view schematically showing the configuration of the process cartridge 100 on the non-drive side. A projection 210c2 on the non-drive side is formed at the magnetic member 210c on the non-drive side. The developing sleeve 210d is supported on the non-drive side by the bearing 222 on the non-drive side while holding the spacer roll 210g therebetween. The bearing 222 on the non-drive side is positioned at a holder 210b3 on the non-drive side via bearing positioning ribs 210b5 on the non-drive side. In addition, the holder 210b3 on the non-drive side is supported by the development container 210b1.

The bearing 222 on the non-drive side has an elongated circular hole, that is, a hole 222a for restricting the movement of the magnetic member on the non-drive side, formed substantially in parallel to a line connecting the rotational center of the photosensitive member 207 and the rotational center of the developing sleeve 210d while being supported by the holder 210b3 on the non-drive side. The phase of a D-cut slide portion 210c6 on the non-drive side is fixed by the engagement of the D-cut slide portion 210c6 with a slide surface 222a3 of the magnetic member movement restricting hole 222a on the non-drive side, so that the magnetic member 210c can be movably supported by the bearing 222 on the drive side.

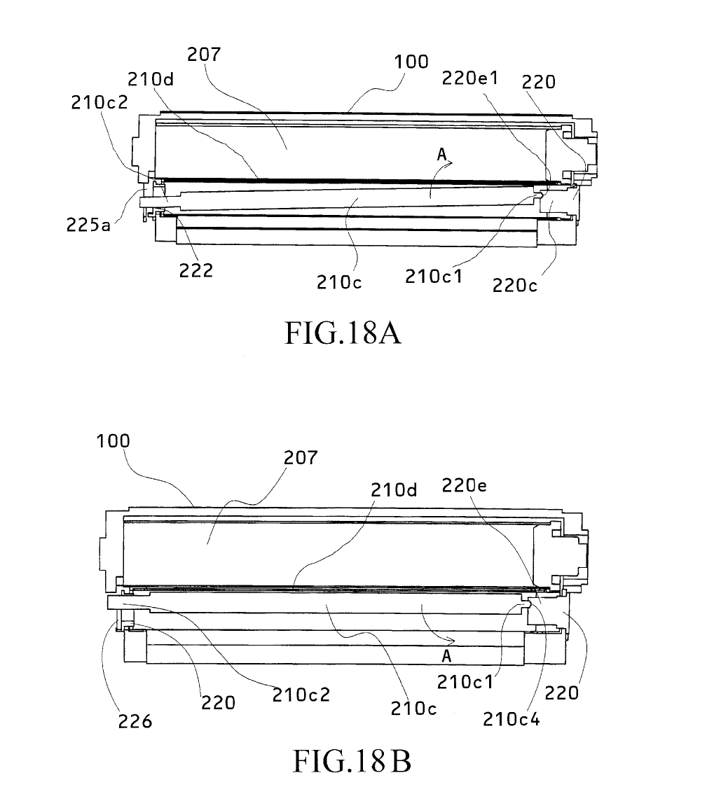

FIG. 17B is a view schematically showing the configuration of the process cartridge 100 during non-use, as viewed in the longitudinal direction. During the non-use, an urging force of a compression spring 226 on the non-drive side is exerted on the projection 210c2 on the non-drive side in the magnetic member 210c, and further, the projection 210c2 on the non-drive side is pressed against a restricting surface 225a2 of the pull-tab 225a (FIG. 15B), to be then positioned. As a consequence, as shown in FIG. 18A, the magnetic member 210c can be kept in separation from the photosensitive member 207. This position is referred to as a second position. Here, FIG. 18A is a cross-sectional view showing the process cartridge 100 in the longitudinal direction during the non-use whereas FIG. 18B is a cross-sectional view showing the process cartridge 100 in the longitudinal direction during the use.

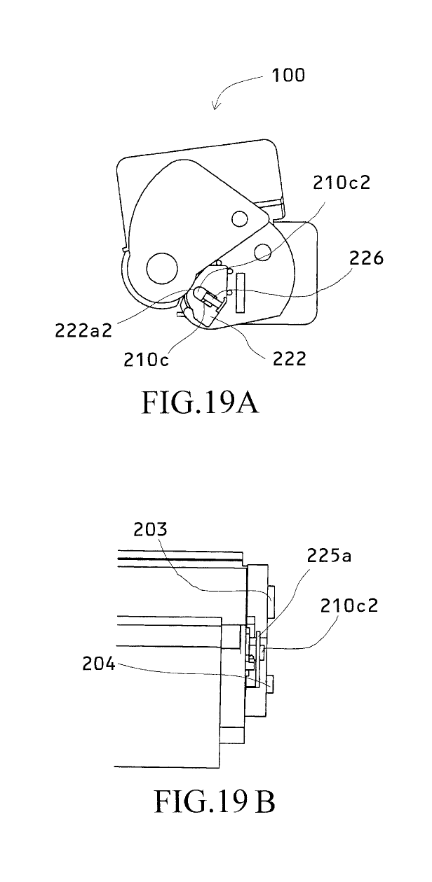

FIG. 19A is a view schematically showing the configuration of the process cartridge 100 on the non-drive side during the use. Here, “the use state” signifies a state in which the toner seal member 225 is withdrawn. In the process cartridge 100 during the use, the projection 210c2 on the non-drive side is urged toward the photosensitive member 207 by the urging force exerted by the compression spring 226 on the non-drive side. As a result, the projection 210c2 on the non-drive side is pressed against a second abutment surface 222a2 of a magnetic member movement restricting hole 222a on the drive side of the bearing 222 on the non-drive side, to be then positioned thereat. In this state, the magnetic member 210c included in the developing sleeve 210d is moved to a predetermined position at which an image can be formed (i.e., a developing operation can be performed) , as shown in FIG. 18B. This position is referred to as a first position.

FIG. 19B is a view schematically showing the process cartridge 100 on the non-drive side, as viewed in the longitudinal direction. Here, a positioning boss 203 on the non-drive side and a unit guide boss 204 are arranged outside of the projection 210c2 on the non-drive side of the magnetic member 210c1 and the pull-tab 225a of the toner seal member 225 in the longitudinal direction. Consequently, when the process cartridge 100 is installed in the laser beam printer 200, the process cartridge 100 can be inserted without bringing the projection 210c2 on the non-drive side and the pull-tab 225a into contact with a main body guide member 9 on the non-drive side.

Incidentally, the configuration in the present embodiment may be applied to that in the second embodiment. Specifically, in the second embodiment, the rotation driving rib 220c2 of the bearing 220 on the drive side is held by the pull-tab 225a of the toner seal member 225 during the non-use: in contrast, the magnetic member 210c can take the two positions by removing the toner seal member 225 during the use.

As described above, the present embodiment can produce the same effects as those in the first and second embodiments even when the process cartridge 100 is installed in the laser beam printer 200. In other words, the magnetic member can be moved by the simple configuration without requiring a user to do cumbersome work.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-167069, filed on Jul. 15, 2009, and Japanese Patent Application No. 2010-096876, filed on Apr. 20, 2010, which are hereby incorporated by reference herein in their entirety.

What is claimed is:

1. A process cartridge detachably attached to an apparatus body of an image forming apparatus comprising:
an image bearing member, on which an electrostatic image is formed;
a developer carrying member that carries a developer for developing the electrostatic image;
a magnetic member that is housed inside of the developer carrying member;
an interval defining member that defines an interval between a surface of the developer carrying member and a surface of the image bearing member; and
a support member that supports the magnetic member in such a manner as to be movable inside of the developer carrying member between a first position, at which a developing operation is performed, and a second position, at which a nearest distance between the surface of the image bearing member and the surface of the magnetic member is greater than that at the first position.

2. A process cartridge according to claim 1, further comprising a force receiving portion that receives, from the apparatus body, a force for moving the magnetic member from the second position to the first position according to an installing operation of the process cartridge in the apparatus body.

3. A process cartridge according to claim 2, wherein
the support member has a slot that movably supports an end of the magnetic member, and
the force receiving portion is disposed at the end of the magnetic member, so as to move the magnetic member upon receipt of the force in abutment against a part of the apparatus body during the installing operation.

4. A process cartridge according to claim 2, wherein
the magnetic member is formed into anon-circular shape in a cross section,
the support member supports the magnetic member in such a manner as to be rotated together with the magnetic member, and
the force receiving portion is provided in the support member, for rotating the support member upon receipt of the force in abutment against a part of the apparatus body during the installing operation, so as to move the magnetic member.

5. An image forming apparatus comprising:
an apparatus body;
an image bearing member, on which an electrostatic image is formed;
a developer carrying member that carries a developer for developing the electrostatic image;
a magnetic member that is housed inside of the developer carrying member;
an interval defining member that defines an interval between a surface of the developer carrying member and a surface of the image baring member; and
a support member that supports the magnetic member in such a manner as to be movable inside of the developer carrying member between a first position, at which a developing operation is performed, and a second position, at which a nearest distance between the surface of the image bearing member and the surface of the magnetic member is greater than that at the first position,
wherein the image bearing member, the developer carrying member, the magnetic member, the interval defining member, and the support member are provided in a process cartridge that is detachably attached to the apparatus body, and
an installation portion that is provided in the apparatus body and mounts the process cartridge thereon.

6. An image forming apparatus according to claim 5 , further comprising
a force applying portion which is provided in the apparatus body, and applies, to the process cartridge, a force for moving the magnetic member from the second position to the first position according to the installing operation of the process cartridge.

7. An image forming apparatus according to claim 6 , wherein
the support member has a slot that movably supports an end of the magnetic member, and
the force applying portion is disposed at the end of the magnetic member, so as to move the magnetic member upon receipt of the force in abutment against a part of the apparatus body during the installing operation.

8. An image forming apparatus according to claim 6, wherein the magnetic member is formed into a non-circular shape in a cross section,
the support member supports the magnetic member in such a manner as to be rotated together with the magnetic member, and
the force applying portion rotates the support member in abutment against a part of the support member during the installing operation, so as to move the magnetic member.
